(19) United States
(12) Patent Application Publication
(10) Pub. No.: US 2006/0265485 A1
(43) Pub. Date: Nov. 23, 2006

(54) Method and apparatus for controlling data transfer in a processing system

(76) Inventors: Sek M. Chai, Streamwood, IL (US); Abelardo Lopez-Lagunas, Toluca (MX)

Correspondence Address: MOTOROLA, INC., 1303 EAST ALGONQUIN ROAD, IL01/3RD, SCHAUMBURG, IL, 60196, US

(21) Appl. No.: 11/131,581

(22) Filed: May 17, 2005

(51) Int. Cl. G06F 15/173

(52) U.S. Cl. 709/223

(57) ABSTRACT

A method (800, 900, 1800) and apparatus (100, 1710, 1950) for controlling data transfer in a processing system (200) accomplishes obtaining a set of input stream descriptors (505, 605), receiving physical parameters, and automatically generating a set of output stream descriptors (705). The set of input stream descriptors are used for transferring a set of target data embedded in a data stream (500, 600) to a device such as a memory, wherein locations of data in the set of target data embedded in the data stream are described by the input stream descriptors. The physical parameters that are received are related to transferring target data to the device. The set of output stream descriptors that are automatically generated can be used for transferring the set of target data to a device in a second data stream, wherein the set of output stream descriptors are determined by using at least one of the input stream descriptors or the physical parameters for improving at least one performance metric.

### FIELD OF THE INVENTION

The present invention relates generally to compiler and processing system design, in particular, in the field of scheduling the fetching of data and the configuration of memory hierarchy.

### BACKGROUND

A processing architecture that is used advantageously for certain applications in which a large amount of ordered data is processed is known as a streaming architecture. Typically, the ordered data is stored in a regular memory pattern (such as a vector, a two-dimensional shape, or a link list) or transferred in real-time from a peripheral. Processing such ordered data streams is common in media applications, such as digital audio and video, and in data communication applications (such as data compression or decompression). In many applications, relatively little processing of each data item is required, but high computation rates are required because of the large amount of data.

Processors and their associated memory hierarchy for streaming architectures are conventionally designed with complex circuits that attempt to dynamically predict the data access patterns and pre-fetch required data from slow memory into faster local memory. This approach is typically limited in performance because data access patterns are difficult to predict correctly for many cases. In addition, the associated circuits consume power and chip area that can otherwise be allocated to actual data processing. To supplement this approach, compilers have been used to schedule data transfers before the actual program execution by the processor. However, traditional compiler techniques are only available for simple data access patterns, and therefore limited in their ability to provide significant performance improvements.

### BRIEF DESCRIPTION OF THE FIGURES

The accompanying figures, where like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 is a flow diagram showing an example of a compiler that generates stream descriptors, in accordance with some embodiments of the present invention;

FIG. 2 is an electrical block diagram of an exemplary processing system, in accordance with some embodiments of the present invention;

FIG. 3 is a data stream diagram that shows an example of target data in a data stream, in accordance with some embodiments of the present invention;

FIG. 4 is a data stream diagram that shows an example of a set of target data within a data stream, in accordance with some embodiments of the invention;

FIGS. 5, 6, and 7 are stream diagrams that illustrate an example of merged target data, in accordance with some embodiments of the present invention;

FIG. 8 is a flow chart of a method for automatic generation of output stream descriptors in accordance with some embodiments of the invention;

FIG. 9 is an exemplary flow chart of a method to automatically generate output stream descriptors in an iterative process, in accordance with some embodiments of the invention;

FIGS. 10, 11 and 12 show a flow chart 1000 of an exemplary method to generate output stream descriptors from input stream descriptors and physical parameters in accordance with some embodiments of the present invention;

FIGS. 13, 14, and 15 show a flow chart 1300 of an exemplary method to generate output stream descriptors from two sets of input stream descriptors and physical parameters, in accordance with some embodiments of the present invention;

FIG. 16 is a flow diagram that shows an example flow of a program in accordance with some embodiments of the present invention;

FIG. 17 comprises two flow diagrams that show example flows of other programs where either the input stream descriptors or output stream descriptors are dependent on scalar values, in accordance with some embodiments of the present invention;

FIG. 18 is a flow chart of a method for automatic generation of a stream loader, in accordance with some embodiments of the invention; and

FIG. 19 is a block diagram that shows a memory controller, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to processing systems having a streaming architecture. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention relates generally to the compiler and memory hierarchy for streaming architectures. In streaming applications, data movement becomes important because data items have short lifetimes. This stream processing model seeks to either minimize data movement by localizing the computation, or to overlap computation with data movement.

Stream computations are localized into groups or self contained such that there are no data dependencies between other computation groups. Each computation group produces an output stream from one or more input streams. Furthermore, processing performed in each stream computation group is regular or repetitive. There are opportunities for compiler optimization to organize the computation as well as the regular access patterns to memory. A computation group is also referred to as a process, and stream computations are also called stream kernels.

When a data item is to be processed, it is typically retrieved from a memory. This typically requires that the memory address of the data item be calculated. Care is taken to avoid memory address aliasing. Also, when the results of the processing are to be written to a memory, the memory address where the result is to be stored typically needs to be calculated. These calculations are dependent upon the ordering of the data in memory.

In accordance with some embodiments of the present invention the calculation of memory addresses is separated from the processing of the data in the hardware of the processor. This may be achieved by using input and output stream units. An input stream unit is a circuit that may be programmed to calculate memory addresses for a data stream. In operation the input stream unit retrieves data items from memory in a specified order and presents them consecutively to another memory or processor. Similarly, an output stream unit receives consecutive data items from a memory or processor and stores them in a specified data pattern in a memory or transfers them within a data stream.

Some embodiments of the present invention may be generally described as ones in which data-prefetch operations in a memory hierarchy are determined by a compiler that takes as inputs physical parameters that define the system hardware and stream descriptors that define patterns of data within streams of data which are needed for processor operations. The physical parameters characterize the abilities of the different memory buffers and bus links in the memory hierarchy, while the stream descriptors define the location and shape of target data in memory storage or in a data stream that is being transferred. Streaming data consists of many target data that may be spread throughout the memory storage in complex arrangements and locations. Using this set of information, the compiler may manipulate the stream descriptors for use by different memory buffers for a more efficient transfer of required data.

Other embodiments of the present invention combine unique compiler techniques with reconfigurable memory connection and control hardware, in which the memory hierarchy may be more optimally configured for a set of access patterns of an application. Reconfigurable hardware utilizes programmable logic to provide a degree of flexibility in reconfiguration of the memory hierarchy, and the compiler may provide the appropriate configuration parameters by analyzing the physical parameters and stream descriptors.

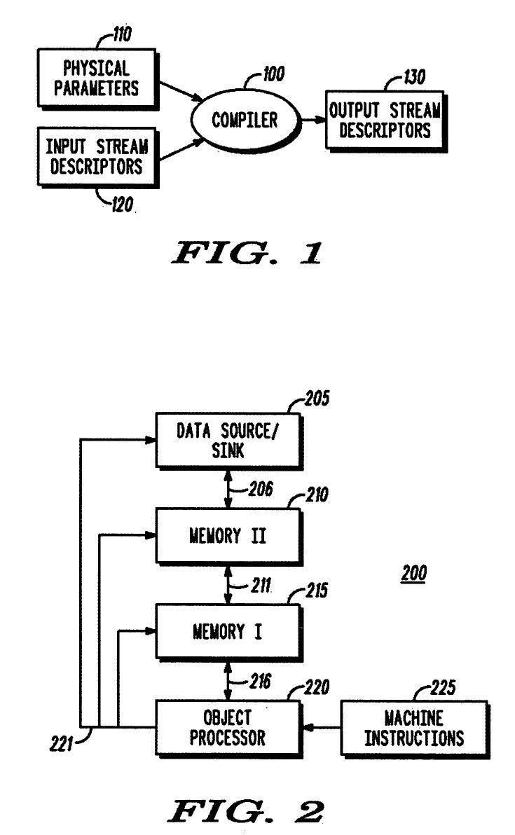

Referring to FIG. 1, a flow diagram shows an example of a compiler that generates stream descriptors in accordance with some embodiments of the present invention. Stream descriptors are used to schedule data movement within a memory hierarchy of a streaming architecture. A compiler 100 receives physical parameters 110 that define appropriate aspects of the streaming architecture and also receives input stream descriptors 120 that define patterns of data within streams of data, wherein the patterns of data comprise a set of data. This is needed for operations performed by the processor, which is also called the target data. The physical parameters 110 include a description of the capabilities of each memory buffer in the memory hierarchy. For example, details such as bus width (W), setup time (SU), number of cycles to move the data in a bus transfer (BC), overhead in the data packet during transmission of data (OH), bus capacitance (C), bus voltage swing (V) and bus clock frequency (F) may be included in the physical parameters 110. In some embodiments, a set of output stream descriptors 130 is automatically generated for different memory buffers in the memory hierarchy.

Referring to FIG. 2, an electrical block diagram of an exemplary processing system 200 is shown, in accordance with some embodiments of the present invention. The object processing system 200 comprises an object processor 220 that operates under the control of programming instructions 225. The object processor 220 is coupled to a first level memory 215, MEMORY I, a second level memory 210, MEMORY II, and a data source/sink 205. The data source/sink 205 is bi-directionally coupled via data bus 206 to the second level memory 210; the second level memory 210 is bi-directionally coupled via data bus 211 to the first level memory 215; and the first level memory 215 is bi-directionally coupled via data bus 216 to the object processor 220. In these embodiments, the object processor 220 optionally controls the transfer of data between the above described pairs of devices (205, 210), (210, 215), and (215, 220) via control signals 221. The object processor may be a processor that is optimized for the processing of streaming data, or it may be a more conventional processor, such as a scalar processor or DSP that is adapted for streaming data.

The arrangement of devices shown in FIG. 2 illustrates a wide variety of possible hierarchical arrangements of devices in a processing system, between which data may flow. For the examples described herein, the data that flows may be described as streaming data, which is characterized by including repetitive patterns of information. Examples are series of vectors of known length and video image pixel information. The data source/sink 205 may be, for example, a memory of the type that may be referred to as an external memory, such as a synchronous dynamic random access memory (SDRAM). In these embodiments, the transfer of data between the data source/sink 205 and the object processor 220 may be under the primary or sole control of the object processor 220. Such an external memory may receive or send data to or from an external device not shown in FIG. 2, such as another processing device or an input device. One example of an external device that may transfer data into a memory 205 is an imaging device that transfers successive sets of pixel information into the memory 205. Another example of an external device that may transfer data into a memory 205 is a general purpose processor that generates sets of vector information, such as speech characteristics. In some embodiments, the data source/sink 205 may be part of a device or subsystem such as a video camera or display. The second level memory 210 may be an intermediate cache memory and the first level memory 215 may be a first level cache memory. In other embodiments, the first level memory 215 may be a set of registers of a central processing unit of the processor 220, and the second level memory 210 may be a cache memory. Each of the first level memory 215, the second level memory 210, and the data source/sink 205 may optionally include a control section (input and/or output control) that performs data transfers to or from each of the first level memory 215, the second level memory 210, and the data source/sink 205 under control of parameters set therein by the object processor 220, or such data transfers may occur under the direct control of the object processor 220. Furthermore, in some embodiments, the first level memory, second level memory, and data source/sink maybe included in the same integrated circuit as the object processor. It will be appreciated that in some embodiments the second level memory 210 may not exist. In other possible embodiments, the control parameters for data source/sink 205, second level memory 210, or first level memory 215 may be statically defined by a compiler 100 during compile-time and preloaded into the memory control sections before operation of the processing system 200.

In accordance with some embodiments of the present invention, the data that is being transferred from the data source/sink 205 to the object processor 220, or from the object processor 220 to the data source/sink 205, is transferred between devices on data buses 206, 211, 216 as streaming data. For this example, a first set of target data is needed for use by an operation to be performed within the object processor 220 under control of the machine instructions 225. The set of target data is included at known locations within a larger set of data that comprises a first data stream that is transferred on data bus 206 between data source/sink 205 and second level memory 210. The first data stream may, for example, comprise values for all elements of each vector of a set of vectors, from which only certain elements of each vector are needed for a calculation.

In a specific example, the first data stream is transferred over bus 206 that comprises element values for 20 vectors, each vector having 8 elements, wherein each element is one byte in length, and the target data set comprises only four elements of each of the 20 vectors. It will be appreciated that one method of transferring the set of target data to the object processor 220 would be to transfer all the elements of the 20 vectors over data buses 206, 211, 216. However, this method may not be the most efficient method. When the data buses 211, 216 are each 32 bytes wide, then by appropriate memory addressing of the first level memory 210, a second data stream may be formed by accessing only the four elements of each vector and forming a second data stream for transfer over buses 211, 216 that comprises essentially only the elements of the set of target data, sent in three groups of four elements from each of eight vectors, each group comprising 32 bytes, with the last group filled out with sixteen null bytes. In this example, the optimized data streams that are transferred over buses 211, 216 are identical, but it will be further appreciated that different physical parameters related to each data stream transfer may be such that more efficiency may be achieved by using different data stream patterns for each of the data stream transfers over the data buses 211, 216. For this example, when the bus width for bus 216 is sixteen bytes, using five transfers each comprising four elements from four of the 20 vectors may be more efficient.

Referring to FIG. 3, a data stream diagram shows an example of target data in a data stream 300, in accordance with some embodiments of the present invention. When the location of the target data in a data stream fits a pattern, the pattern may typically be specified by using data stream descriptors. Stream descriptors may be any set of values that serve to describe patterned locations of the target data within a data stream. One set of such stream descriptors consists of the following: starting address (SA), stride, span, skip, and type. These parameters may have different meanings for different embodiments. Their meaning for the embodiments described herein is as follows. The type descriptor identifies how many bytes are in a data element of the target data, wherein a data element is the smallest number of consecutive bits that represent a value that will be operated upon by the processor 220. For example, in a pixel image comprising pixels that represent 256 colors, a data element would typically be 8 bits (type=1), but a pixel representing one of approximately sixteen million colors may be 24 bits (type=3). For speech vectors, each element of a speech vector may be, for example, 8 bits. In FIG. 3 and for the example embodiments described below, the type identifies how many 8 bit bytes are in an element. Thus, in FIG. 3, the type is 1. In FIG. 3, each element of the data stream is identified by a sequential position number. When the data stream is stored in a memory, these positions would be memory addresses. Data streams described by the descriptors of this example and following examples may be characterized by a quantity (span 315) of target data elements that are separated from each other by a first quantity (stride 310) of addresses. From the end of a first span of target data elements to the beginning of a second span of target data elements, there may be a second quantity of addresses that is different than the stride 310. This quantity is called the skip 320. Finally, a starting position may be identified. This is called the starting address 305 (SA). For the example of FIG. 3, the values of the stream descriptors 325 (SA 305, stride 310, span 315, skip 320, type) are (0, 3, 4, 5, 1). In this example, the target data elements may be, for example, the 0^{th}, 3^{rd}, 6^{th}, and 9^{th} elements of a set of vectors, each vector having 14 elements. It will be appreciated that a set of stream descriptors may also include a field that defines the number of target data elements in the data stream.

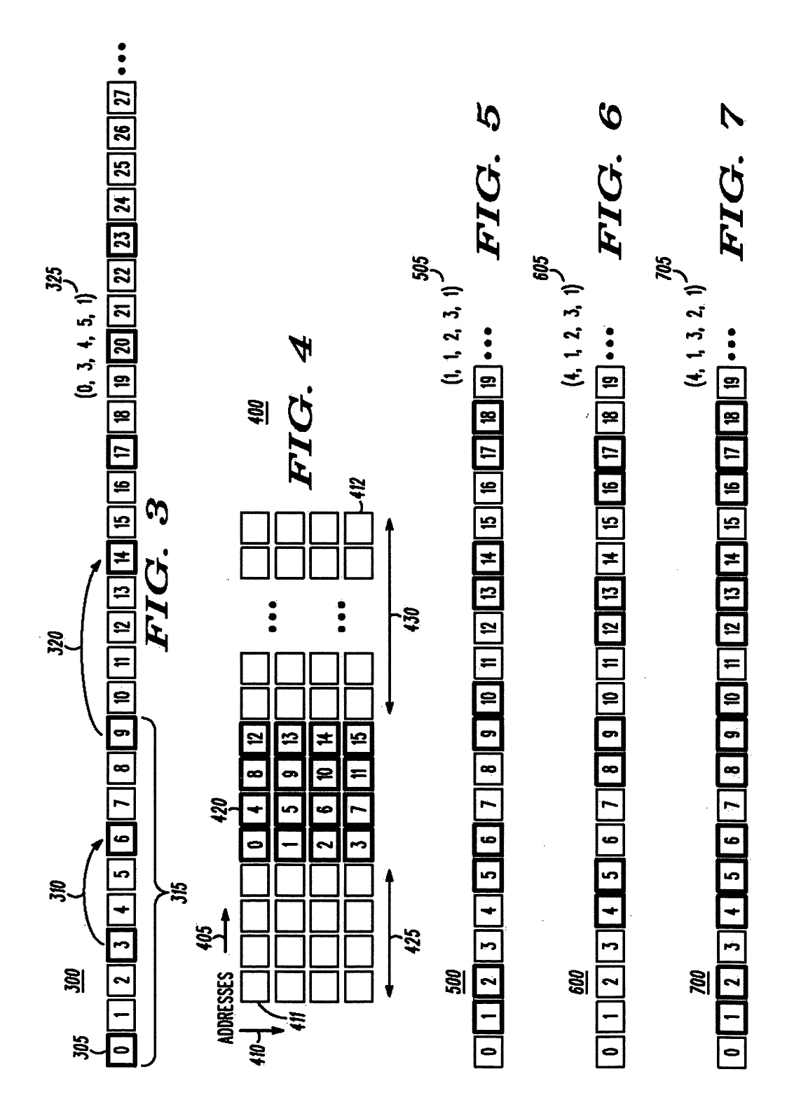

Referring to FIG. 4, a data stream diagram 400 shows an example of a set of target data within a data stream that may be stored in the second level memory 210, in accordance with some embodiments of the invention. The set of target data in this example comprises 16 elements identified as elements zero through 15 located as a two-dimensional pattern in a data stream that comprises a set of target data elements stored as 4 rows of 100 elements having a relative starting address 411 of value 0 and a relative ending address 412 of value 399 within second level memory 210. It will be appreciated that the row address 410 and column address 405 form a relative address to which elements may be indexed because the 4 rows of 100 elements are stored consecutively in a physical memory buffer such as the second level memory 210. Thus in each row there is a group of 4 elements 425 at column addresses 405 below those of the set of target data and there is a group of 92 elements 430 at column addresses 405 above those of the set of target data. In this example, the set of target data is described to the compiler 100 using input stream descriptors 110 of values (4, 100, 4, −299, 1), which indicates that the starting address of the set of target data is 4, that target data of one byte width elements (the type) is found in a pattern of 4 elements (the span) in which the elements are separated by 100 addresses (the stride), and that a next group starts 299 addresses before the last element of a previous group. With the additional knowledge that the set of target data comprises 16 elements, this information could be used to transfer the set of target data to the first level memory 215 (or to the object processor 220 when there is no first level memory in the particular processing system) using 16 fetches of one byte each with the addresses defined by the input stream descriptors. However, in accordance with an embodiment of the present invention, the compiler 100 uses a bus width parameter that is included in the physical parameters 120 to determine that a bus width of 32 bits is available between the second level memory 210 and the object processor 220, and uses this information to generate output stream descriptors of values (4, 25, 4, −74, 4), which indicates that the starting address of the set of target data is 4, that target data of four byte wide elements (the type) are found in a pattern of 4 elements (the span) in which the four byte wide elements are separated by 25 four byte addresses (the stride), and that a next set of target data starts 25 four byte addresses after the four byte wide element of a previous group. The compiler also generates the machine level instructions that control the object processor so that they accommodate the fact that the target data is received by the first level memory 210 or object processor 220 in four fetches that acquire the object elements in a different order {(0, 4, 8, 12),(1, 5, 9, 13),(2, 6, 10, 14),(3, 7, 11, 15)} than if the input stream descriptors were used {0, 1, 2, 3, 4, 5, 6, 7, 8, 9, 10, 11, 12, 13, 14, 15). It will be appreciated that by automatically generating the output stream descriptors as shown in this example, the target data may be fetched more quickly than by using the input data stream descriptors. It will be appreciated that the object processor 220 may properly reference the order of the object elements once transferred.

Referring to FIGS. 5, 6, and 7, data stream diagrams 500, 600, 700 show examples of two sets of target data within a data stream that may be stored in the second level memory 210, and a set of merged target data within the data stream, in accordance with some embodiments of the present invention. A first set of target data within a data stream that is identified in FIG. 5 by bold outlines is identified to the compiler 100 by input stream descriptors 505 (1, 1, 2, 3, 1). A second set of target data within the same data stream, that is identified in FIG. 6 by bold outlines and that is to be processed by the same object processor in a related but independent operation, is identified to the compiler 100 by input stream descriptors 605 (4, 1, 2, 3, 1). The compiler 100 uses a bus width parameter that is included in the physical parameters 120 to determine that a bus width of 32 bits is available between the second level memory 210 (in which the data stream is temporarily stored) and the object processor 220, and that the object processor has the necessary functionality to make efficient use of both set of target data in an essentially simultaneous manner. The compiler uses this information and the two sets of input stream descriptors to automatically generate two individual addresses (1, 2) and a set of output stream descriptors 705 (4, 1, 3, 2, 1) for a merged set of target data. The compiler also generates the machine level instructions that control the object processor so that they accommodate the organization of the target data as described by the two individual addresses and the set of output stream descriptors. It will be appreciated that transferring the target data using two individual addresses and the set of output stream descriptors requires fewer fetches than fetching the two set of target data independently. The set of output stream descriptors described above is an example of merged output stream descriptors. It will be appreciated that more than one set of target data sets from one or more data streams could be merged. Furthermore, it will be appreciated that the object processor 220 may properly reference the order of the object elements once transferred.

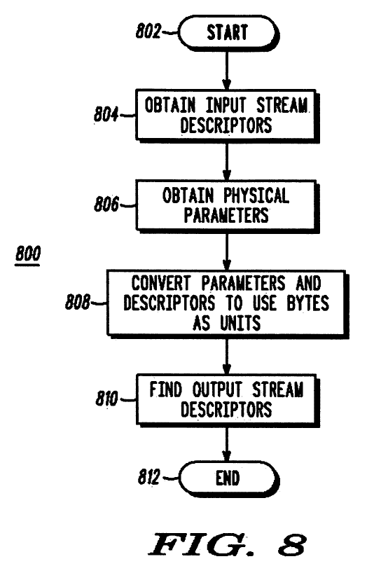

FIG. 8 is a flow chart of a method 800, in accordance with some embodiments of the invention, for automatic generation of output stream descriptors. The method may be used in a compiler or hardware circuits, or the method may be accomplished by executable code (generated by a compiler) that is executed in the object processor 220 or another processing in a processing system such as processing system 200.

Referring to FIG. 8, following start step 802, an input stream descriptor 102 is obtained at step 804 either from a program source code, another compiler process, a process in the object processor 220 or another processor. In an alternative embodiment, additional input stream descriptors may serve as inputs to this step 804. At step 806, the physical parameters 110 are obtained as user input, from program source code, another compiler process, an object processor or other processor process. At step 808, fields in the input stream descriptors 102 and physical parameters 110 that are related to data size are converted into common units so that mathematical calculation may be performed. In FIG. 8, the common unit for descriptors and parameters that relate to data size is bytes, but other sizes could be used, such as bits or octets. At step 810, the output stream descriptors 130 are derived from the input stream descriptors 120 and physical parameters 110. The process terminates at step 812. Corresponding executable code that controls one or more transfer operations that are performed according to the first output stream descriptors is generated. The executable code may include memory control unit settings or instructions and/or object processor instructions that are formulated at step 810 to correspond to the output stream descriptors. The method is designed to result in an improvement of a performance metric, such as latency, bus utilization, number of transfers, power consumption, and total buffer size.

In other words, the method may be described as a procedure for controlling data transfers in a processing system. The method comprises obtaining a set of first input stream descriptors at step 804 that describe data locations of a set of target data embedded within a first data stream that can be transferred by the first data stream to a first device (such as the first level memory 215 or the object processor 220), The set of first input stream descriptors may be received in a set of processor instructions at step 804 that include an operation for transferring the set of target data. The method further comprises obtaining first physical parameters related to transferring data to the first device at step 806. The method also comprises automatically generating a set of first output stream descriptors at step 810 that may be used for transferring the first set of target data to the first device embedded within a second data stream, wherein the set of first output stream descriptors are determined from at least one of the set of first input stream descriptors and at least one of the first physical parameters. As shown by specific examples below, the automatic generation of the set of first output stream descriptors typically results in an improvement of at least one performance parameter that measures the transfer of the first set of target data. In some embodiments, the method is performed by a compiler, which receives a description of an operation to transfer the target data that could be performed using the set of first input stream descriptors and the first physical parameters. Configuration settings of a processing system may also be obtained by the compiler. The compiler may have program code that is loaded from a software media (such as a floppy disk, downloaded file, or flash memory) that generates object code (executable code) in which the set of first output stream descriptors are embedded. In other embodiments, the compiler may generate executable code that allows the processing system to perform the method described with reference to FIG. 8, or a modification of the method. For example, in some embodiments, the physical parameters may be obtained from a result of an operation within the processing system, such as a dynamic memory reconfiguration operation. In some embodiments, a memory controller for an intermediate memory may receive input stream parameters and output stream parameters and use them to read the set of target data from a first memory stream and to generate a second data stream into which the memory writes the target data.

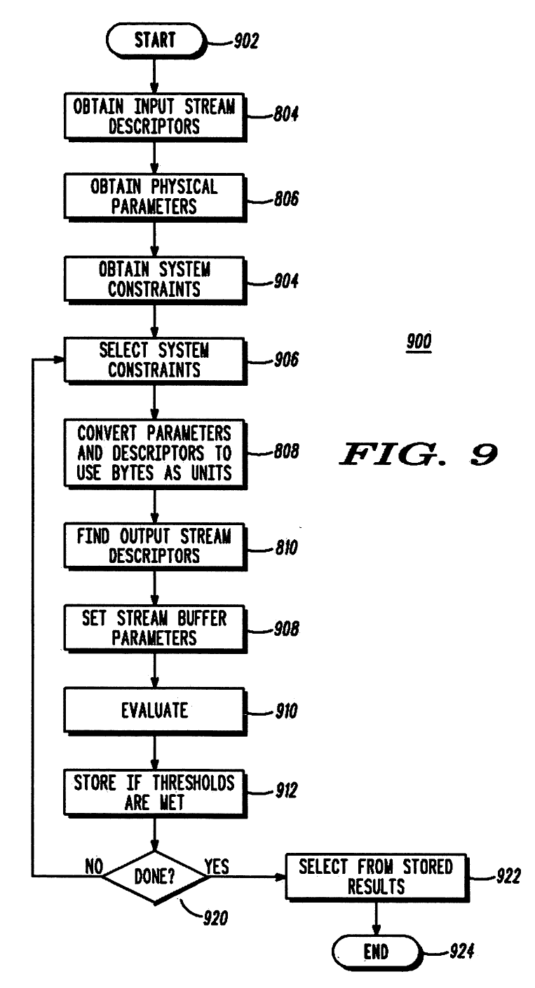

Referring to FIG. 9, a flow chart shows a method 900 to automatically generate output stream descriptors in an iterative process, in accordance with some embodiments of the invention. The method may be used in a compiler or hardware circuits, or the method may be accomplished by executable code (generated by a compiler) that is executed in a processing system. This method 900 may be useful in a processing system with reconfigurable hardware where programmable logic is used to control the memory hierarchy. In an example embodiment, the compiler 100 may be used to automatically generate output stream descriptors, but also to provide appropriate configuration parameters of the programmable logic.

Referring to FIG. 9, following a start step 902, the input stream descriptors are obtained at the step 804, and the physical parameters are obtained at the next step 806. System constraints are then derived from physical parameters at step 904. The system constraints are related to the available range of aspects of the reconfigurable hardware and are used to limit the selection of parameters, at step 906 to be defined later, in order to evaluate against a set of performance metrics. The system constraints may include the maximum buffer size in the memory hierarchy, the maximum latency (such as setup time), the maximum bus width, and the maximum physical area of a memory circuit. In another embodiment, system constraints may be obtained from user input, program source code, or other compiler process.

Steps 906, 808, 810, 908, 910, 912, and 920 describe an iterative optimization method. In this method, each iteration instantiates a set of variables for the search space of system constraints obtained at step 904. At step 906, a set of system constraints is selected. At step 808, fields in the input stream descriptors 120 and physical parameters 110 are converted into common units so that mathematical calculation may be performed. At step 810, the output stream descriptors are then derived from the input stream descriptors and selected physical parameters. At step 908, the parameters of the memory buffer are selected based on output stream descriptors. The parameters may include such information as buffer size (BS) and bus width (W), and must be selected within the limits of the chosen system constraints obtained at step 904.

At step 910, the candidate output stream descriptors are evaluated using one or more performance metrics, such as bus utilization, number of transfers, power consumption, and total buffer size. These performance metrics are derived from physical parameters 110 obtained at step 806, system constraints obtained at step 904 and the output stream descriptors 130 generated at step 810. In one example embodiment, the actual burst capacity (ABC) may be derived as follows:

$$ABC = \frac{number\_of \_data \_elements}{( SU + BC ) \cdot ( number\_of \_transfers )} [ \frac{bytes}{cycle} ] \qquad EQ1$$

where the number_of_data_elements is the total number of target data elements in a data stream having target data defined by a set of stream descriptors, SU is the setup time defined by the number of cycles to initiate a transfer, BC is the number of cycles to move the target data, and number_of_transfers is the number of times a transfer is initiated. For data streams that are indefinite in size, such as video images from an imaging sensor, the number_of_data_elements and number_of_transfers are defined for a specific time frame such as a frame period. In the same embodiment, the maximum bus utilization (MBU) may be defined as follows:

$$MBU = \frac{W - OH}{1 \_cycle} [ \frac{bytes}{cycle} ] \qquad EQ2$$

where W is a physical parameter defining the bus width, OH is the overhead in the data packet during transmission of data, and 1_cycle is a unit denominator to normalize the equation as a rate. Using ABC and MBU, the actual bus utilization, ABU, may be derived as follows:

$$ABU = \frac{ABC}{MBU} \times 100 [ \% ] \qquad EQ3$$

where ABC is the actual burst capacity and MBU is the maximum bus utilization. Referring again to FIG. 9, for one embodiment at step 910, the equation EQ3 is used to measure the capability of the output stream descriptor 130 to pack target data within a transfer on the bus. An ABU value close to 100% is desirable as a high percentage represents high bus utilization. It will be appreciated that the iterative process described above will typically optimize the performance metric.

It will be appreciated that the power consumption performance metric may be related to ABU. In another embodiment, power consumption may be estimated from the number of transitions of each bus line as follows:

$$P = ( number\_of \_transfers \cdot W \cdot H ) \frac{1}{2} {CV}^{2} F [ watts ] ] \qquad EQ4$$

where P is the dissipated dynamic power, number_of_transfers is the number of times a transfer is initiated, W is a physical parameter defining the bus width, H is the number of transitions in each bus line, C is a physical parameter defining bus capacitance, V is a physical parameter defining bus voltage swing, and F is a physical parameter defining bus frequency. The value H may be computed by finding the number of transitions between each data bit in the data stream. Referring again to FIG. 9, for one embodiment at step 910, the equation EQ4 is used to measure the capability of the output stream descriptor 130 to reduce the number of transfers for the data stream, and thereby an optimized value of P is obtained in the iterative process 900. In reference to FIG. 4, a low P value indicates the output stream descriptors' ability to pack target data that results in smaller number of transfers. In reference to FIGS. 5-7, a low P value indicates the output stream descriptors' ability to pack target data from two data streams that result in smaller number of transfers. Other methods that are known in the art, such as bus encoding, frequency scaling, may be also be used to reduce power consumption.

In yet another embodiment, at step 910, the number_of_transfers indicating the number of times a transfer is initiated, described by the output stream descriptors 130, can be compared against system constraints obtained at step 904. Furthermore, the size of the memory buffer selected at step 908 may be compared against system constraints obtained at step 904. Values for the memory buffer size and number_of_transfers that are within range defined by the system constraints are desirable.

If the candidate output stream descriptors meet the thresholds set by the user and system constraints, then the output stream descriptors are stored at step 912. At decision step 920, a check is made to determine whether the design process is completed. The process may be completed when a specified number of candidate output stream descriptors have been evaluated, or when a desired number of system constraints have been selected. When the process is not complete, as indicated by the negative branch from decision step 920, flow returns to step 906 and a new set of system constraints are selected. When the design process is completed, as indicated by the positive branch from decision step 920, an output stream descriptor is selected from the set of candidate output stream descriptors at step 922. The process terminates at step 924.

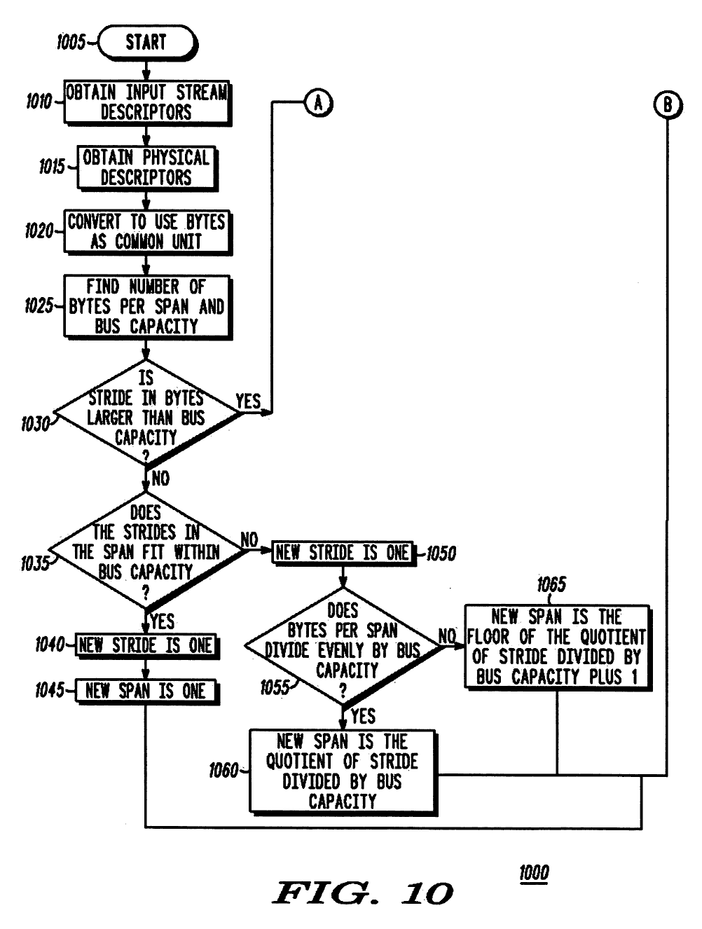

Referring to FIGS. 10, 11 and 12, a flow chart 1000 shows an exemplary method to generate output stream descriptors from input stream descriptors and physical parameters in accordance with some embodiments of the present invention. The method may be used in a compiler or hardware circuit, or the method may be accomplished by executable code (generated by a compiler) that is executed in a processing system.

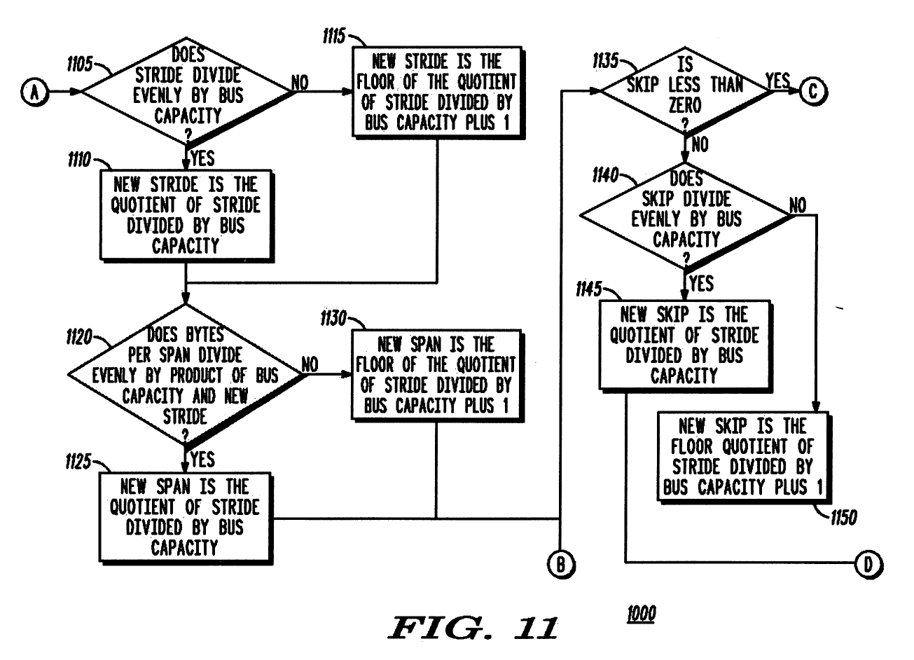

The method starts at step 1005. At step 1010, input stream descriptors are obtained. Physical parameters are obtained at step 1015. At step 1020, stride and skip are converted to use bytes as units, and the physical parameters are also converted to use bytes as units, where appropriate. The type and span are used at step 1025 to find the number of bytes per span. At step 1025, the bus capacity is also calculated as follows:

$$bus\_capacity = \frac{W - OH}{SU + BC} \cdot 1 \_cycle [ bytes ] \qquad EQ5$$

where W is a physical parameter defining the bus width, OH is the overhead in the data packet during transmission of data, SU is the setup time defined by the number of cycles to initiate a transfer, BC is the number of cycles required to move the target data and 1_cycle is a product term to convert the equation with bytes as a unit. At step 1030, when the stride (in bytes) is larger than bus capacity (in bytes), the method continues at step 1105 illustrated in FIG. 11. At step 1030, when the stride is not larger than bus capacity, a determination is made at step 1035 as to whether the strides in the span fit within the bus capacity. When the strides in the span fit within the bus capacity, the new stride value is set to one at step 1040 and the new span value is set to one at step 1045, and the method continues at step 1135 illustrated in FIG. 11. When the strides in the span do not fit within bus capacity at step 1035, the new stride value is set to one and a determination is made at step 1055 as to whether the number of bytes per span divide evenly by the bus capacity. When the number of bytes per span divide evenly by the bus capacity, the new span value is set to the quotient of stride divided by bus capacity at step 1060 and the method continues at step 1135. When the number of bytes per span does not divide evenly by bus capacity, the new span value is set to the floor of the quotient of stride divided by bus capacity plus one at step 1065, and the method continues at step 1135.

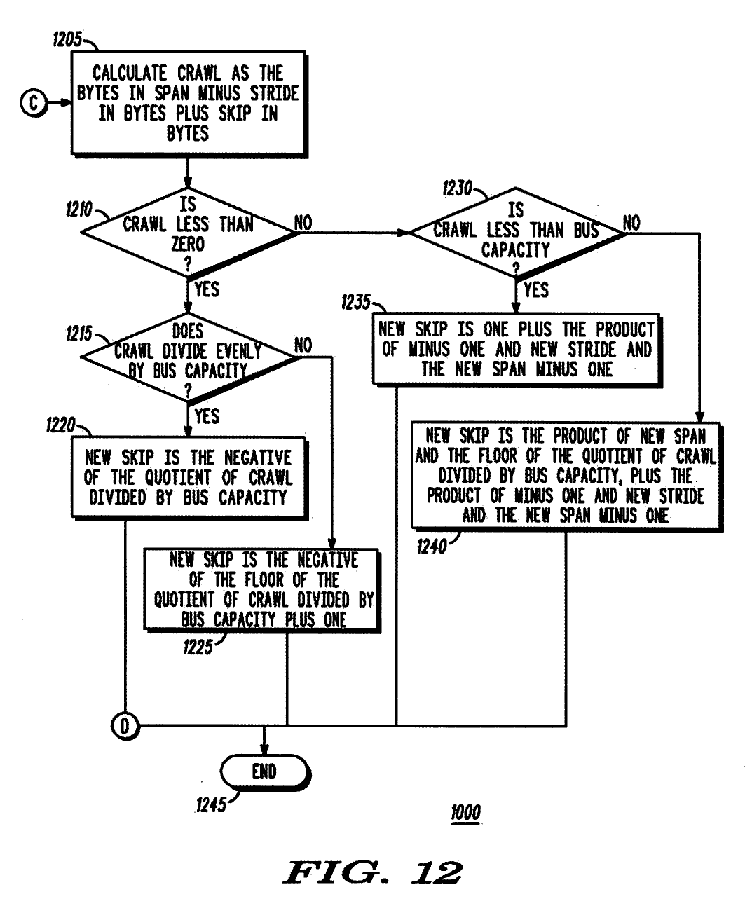

At step 1105, a determination is made as to whether the stride divides evenly by bus capacity. When the stride divides evenly by bus capacity, the new stride value is set at step 1110 to the quotient of stride divided by bus capacity and the process continues at step 1120. When the stride does not divide evenly by the bus capacity at step 1105, the new stride value is set at step 1115 to the floor of the quotient of stride divided by bus capacity plus one and the method continues at step 1120, where a determination is made as to whether the bytes per span divide evenly by product of bus capacity and new stride. When the bytes per span divide evenly by the product of bus capacity and new stride, the new span value is set at step 1125 to the quotient of stride divided by bus capacity and the method continues at step 1135. When the bytes per span do not divide evenly by the product of bus capacity and new stride, the new span value is set at step 1130 to the floor of the quotient of stride divided by bus capacity plus one, and the method continues at step 1135, where a determination is made as to whether the skip is less than zero. When the skip is less than zero, the method continues at step 1205 illustrated in FIG. 12. When the skip is not less than zero, a determination is made at step 1140 as to whether the skip divide evenly by bus capacity. When the skip divides evenly by bus capacity, the new skip value is set to the quotient of skip divided by bus capacity at step 1145, and the method ends at step 1245. When the skip does not divide evenly by bus capacity, the new skip value is set at step 1150 to the floor of the quotient of skip divided by bus capacity plus one, and the method ends at step 1245.

At step 1205, a crawl is calculated as the number of bytes in span minus number of bytes in stride plus the skip. A determination is then made as to whether the crawl is less than zero at step 1210. When the crawl is less than zero, a determination is made at step 1215 as to whether the crawl divides evenly by the bus capacity. When the crawl divides evenly by bus capacity, the new skip value is the negative of the quotient of the crawl divided by bus capacity and the method ends at step 1245. When at step 1215 the crawl does not divide evenly by bus capacity, the new skip value is the negative of sum of one and the floor of the quotient of the crawl divided by the bus capacity, and the method ends at step 1245. When at step 1210 the crawl is not less than zero, a determination is made at step 1230 as to whether the crawl is less than the bus capacity. When the crawl is less than bus capacity, the new skip value is determined at step 1235 as
New_skip=−1*new_stride*(new_span−1)+1
(wherein * is the multiplication operator) and the method ends at step 1245. At step 1230, when the crawl is not less than bus capacity, the new skip value is determined at step 1240 as
New_skip=−1*new_stride*(new_span−1)+(new_span*floor(crawl/bus_capacity)
and the method ends at step 1245. The new stride, new span, and new skip become parts of the output stream descriptors. The type is set to the physical parameter defining bus width (W). The output starting address is equal to the input starting address.

It will be appreciated that by using the above method, the output stream descriptors may be used to transfer the target data in a manner that improves the bus capacity performance parameter in many situations using the single iteration described for FIGS. 10-12.

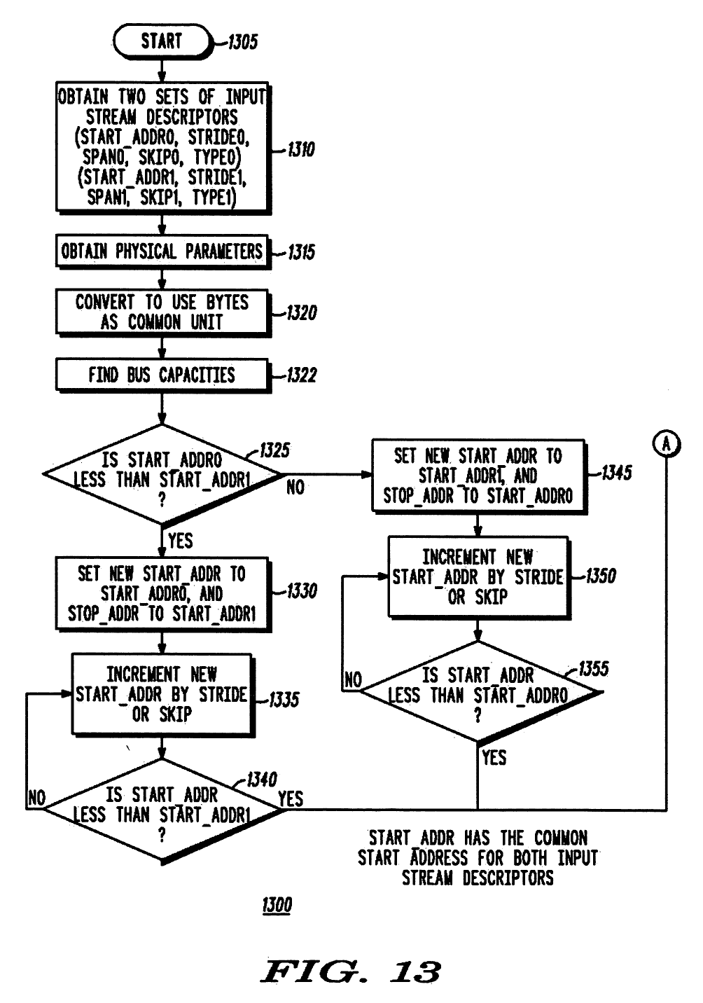

Referring to FIGS. 13, 14, and 15, a flow chart 1300 shows an exemplary method to generate output stream descriptors from two sets of input stream descriptors and physical parameters, in accordance with some embodiments of the present invention. The method may be used in a compiler or hardware circuit, or the method may be accomplished by executable code (generated by a compiler) that is executed in a processing system.

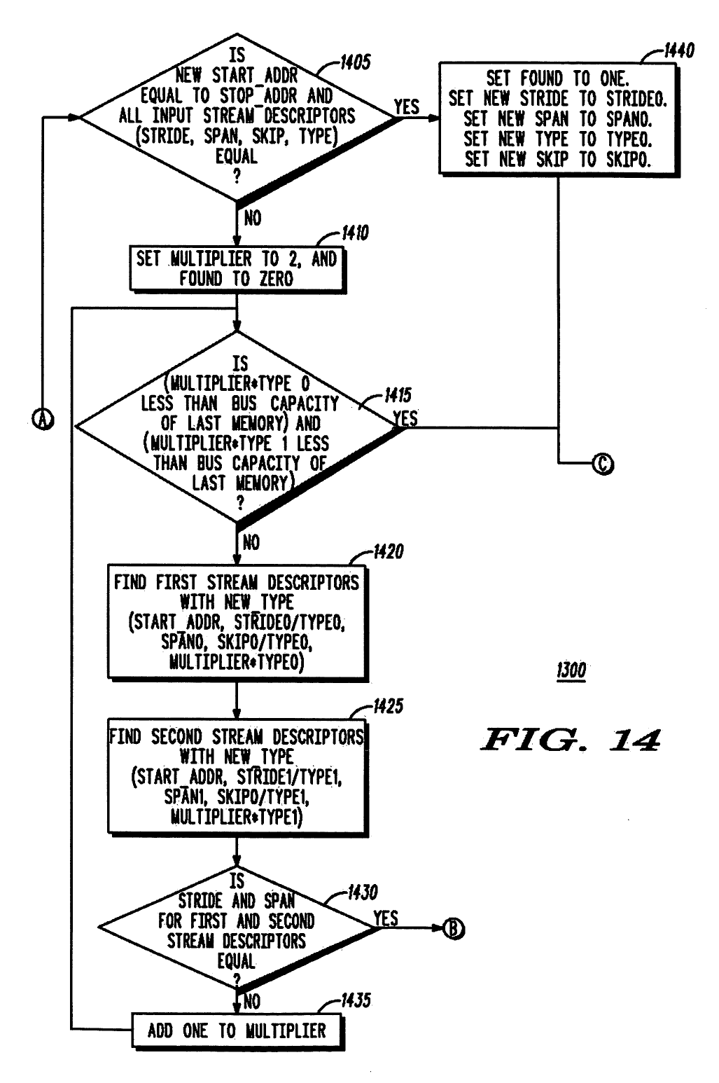

The method starts at step 1305. At step 1310, two sets of input stream descriptors are obtained: (start_addr0, stride0, span0, skip0, type0) and (start_addr1, stride1, span1, skip1, type1). At step 1315, physical parameters are obtained, which in the example of this embodiment are the bus width of a first memory (such as the second level memory 210) and the bus width of the last memory (such as the first level memory 215). The stride and skip from the two sets of input stream descriptors are converted at step 1320 to use bytes as units. At step 1320, the physical parameters are also converted to use bytes as units, where appropriate. At step 1322, the bus capacities for the first and second level memories (210 and 215) are calculated according to equation EQ5. A determination is then made at step 1325 as to whether start_addr0 is less than start_addr1, and when it is new_start_addr is set to start_addr0 and stop_addr is set to start_addr1 at step 1330, and then new_start_addr is incremented at step 1335 by the stride if the target data is within a span, otherwise new_start_addr is incremented by skip value. A determination is then made at step 1340 as to whether the new_start_addr is less than start_addr1, and when it is, the method continues at step 1405 (FIG. 14). When the start addr0 is not less than start_addr1 at step 1340, the method continues by looping to step 1335. At step 1325, when the start_addr0 is not less than start_addr1, the new_start_addr is set to start_addr1, and stop_addr is set to start_addr0 at step 1345, and then new_start_addr is incremented by the stride or skip value at step 1350 and a determination is made at step 1355 as to whether the new_start_addr is less than start_addr0. When new_start_addr is less than start_addr0 at step 1355, the method continues at step 1405 (FIG. 14). When new_start_addr is not less than start_addr0 at step 1355, the method continues by looping to step 1350.

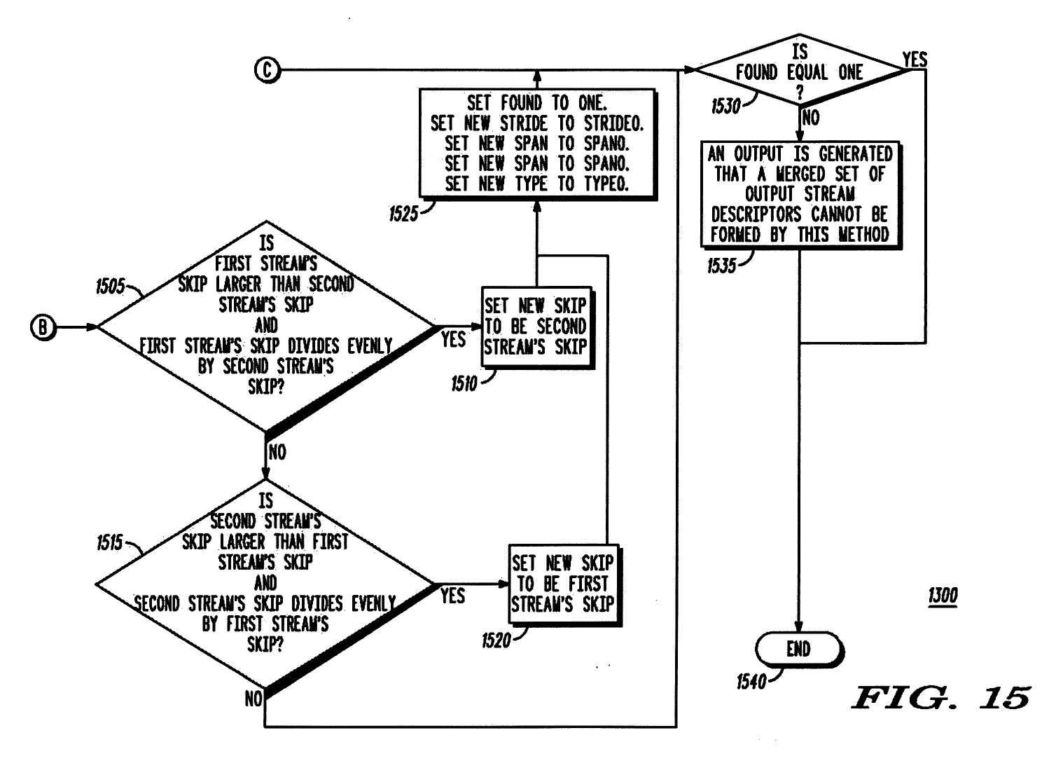

At step 1405, a determination is made as to whether the new start_addr is equal to the stop_addr and whether all the input stream parameters (stride, span, skip, type) are equal, in order to determine whether the input stream descriptors differ only by the start addresses (start_addr0 and start_addr1). When both equalities are not true, a multiplier value is set to 2 and a found value is set to zero at step 1410. Then a determination is made at step 1415 as to whether (multiplier*type0 is less than the bus capacity of last memory) and (multiplier*type1 is less than the bus capacity of last memory). When both parts of the determination are true, the method continues at step 1530 (FIG. 15). At step 1405, when both equalities are true, the value of found is set to one, the value of new stride is set to stride0, the value of new span is set to span0, the value of new type is set to type0, and the value of new skip is set to skip0 at step 1440 and the method continues at step 1530 (FIG. 15). At step 1415, when both parts of the determination are not true, first stream descriptors (new_start_addr, stride0/type0, span0, skip0/type0, new_type) having new_type=multiplier*type0 are determined at step 1420 using the method described above with reference to flow chart 1000 (FIGS. 10-12). Second stream descriptors (new_start_addr, stride1/type1, span1, skip1/type1, new_type) having new_type=multiplier*type1 are determined at step 1425, also using the method described above with reference to flow chart 1000 (FIGS. 10-12). At step 1430, a determination is made as to whether the stride and span for the sets of first and second stream descriptors are equal, and when they are, the method continues at step 1505 (FIG. 15). At step 1430, when stride and span for the sets of first and second stream descriptors are not equal, the multiplier is incremented by one at step 1435 and the method continues by looping to step 1415.

At step 1505, a determination is made as to whether the first stream's skip is larger than second stream's skip and the first stream's skip divides evenly by the second stream's skip. When both parts are true at step 1505, the new skip is set to the first stream's skip value at step 1510 and the method continues at step 1525. When either part is not true at step 1505, then a determination is made at step 1515 as to whether the second stream's skip is larger than the first stream's skip and the second stream's skip divides evenly by the first stream's skip. When both parts are true at step 1515, the new skip is set to the second stream's skip value at step 1520 and the method continues at step 1525, wherein found is set to one, new stride is set to stride0, new span is set to span0, and new type is set to type0, and the method continues at step 1530, where a determination is made as to whether found is equal to one. When found is equal to one at step 1530, the method ends at step 1540. When found is not equal to one at step 1530, an output is generated that a merged set of output stream descriptors cannot be formed by this method.

It will be appreciated that by using the above method described for FIGS. 13-15, the output stream descriptors may be used to transfer the target data in a manner that improves the bus capacity performance parameter in many situations.

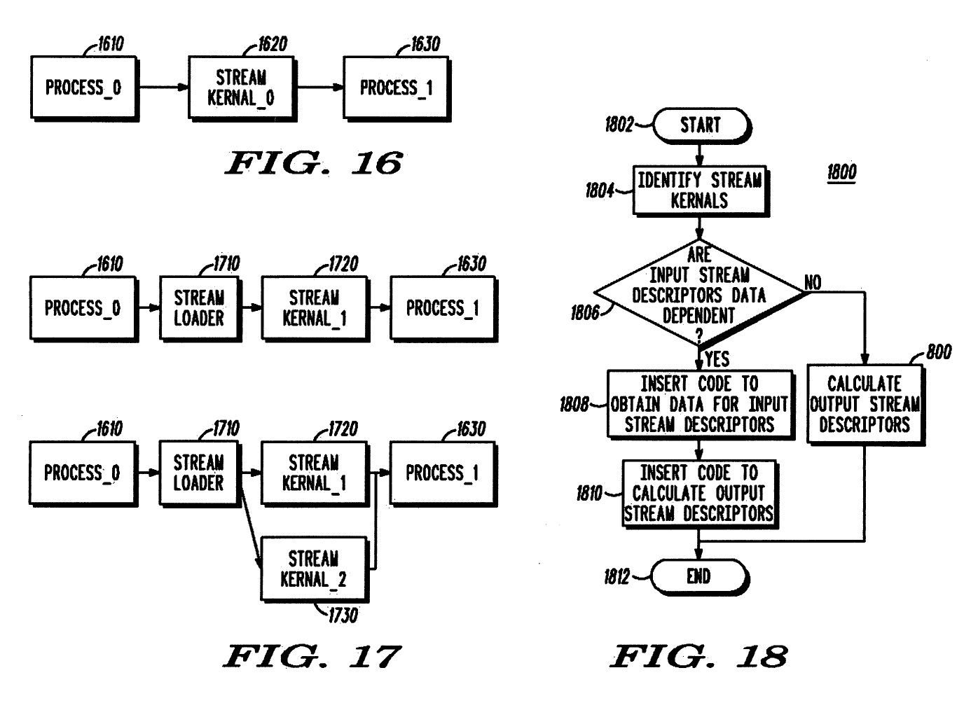

Referring to FIG. 16, a flow diagram shows an example flow of a program in accordance with some embodiments of the present invention. The program may be automatically generated by a compiler and executed in a processing system such as that described with reference to FIG. 2. The control starts with the first process 1610 which in one embodiment executes code that processes scalar data. The control is then transferred to a set of code that is a stream kernel 1620 and when completed the control is transferred to the last process 1630. A stream kernel 1620 is a process that operates on data defined by at least a set of source stream descriptors, and generates data defined by at least a set of destination stream descriptors. Either or both of the sets of source and destination stream descriptors may be output stream descriptors that have been generated in accordance with embodiments of the present invention. In one embodiment, a stream kernel may be identified by the compiler or defined by user or programmer input such that the stream kernel 1620 executes on a streaming architecture. The first process 1610 and last process 1630 operate on scalar data. In some embodiments, the last process 1630 may start before the stream kernel 1620 starts when there are no data dependencies.

Referring to FIG. 17, two flow diagrams show example flows of other programs where either the input stream descriptors 120 or output stream descriptors 130 are dependent on scalar values operated on by the first process 1610, in accordance with some embodiments of the present invention. These other programs may be automatically generated by a compiler and executed in a processing system such as that described with reference to FIG. 2. In a first type of embodiment, the first process 1610 transfers control to a stream loader 1710 which obtains the proper scalar value and computes the stream descriptors for a stream kernel 1720. After stream kernel 1720 completes, control is transferred to the last process 1630. In some embodiments, the last process 1630 may start before the stream kernel 1720 starts when there are no data dependencies. The stream loader 1710 may comprise an apparatus such as a state machine, that operates without a central processing unit, and which may be an application specific integrated circuit. Alternatively, the stream loader may comprise a function accomplished by the processing system 200.

Again referring to FIG. 17, in embodiments of a second type, the first process 1610 may contain a decision step that determines whether the flow of the program is transferred from the stream loader 1710 to the first stream kernel 1720 or to a second stream kernel 1730. In another embodiment of the second type, a decision step in the first process 1610 determines a scalar data value that may change the stream descriptors for either first stream kernel 1720 or second stream kernel 1730. In yet another embodiment of the second type, the first process 1610 contains code that determines a scalar data value that changes the stream descriptors for both stream kernels (1720 and 1730), and both stream kernels (1720 and 1730) are to be executed in parallel in different object processors 220. As shown in FIG. 17, a stream loader 1710 obtains the proper scalar value and computes the stream descriptor for at least one of the stream kernels 1720, 1730. The control is transferred to the last process 1630 upon completion of at least one of the stream kernels 1720, 1730. In some embodiments of the second type, the last process 1630 may start before either the first stream kernel 1720 or the second stream kernel 1730 starts when there are no data dependencies.

FIG. 18 is a flow chart of a method 1800, in accordance with some embodiments of the invention, for automatic generation of the stream loader 1710. The automatic generation of the stream loader 1710 may be performed by a compiler for execution in a processing system such as that described with reference to FIG. 2, or may be performed in a processing system such as that described with reference to FIG. 2 using executable code generated by a compiler, as described below. Referring to FIG. 18, following start step 1802, the stream kernels, such as stream kernels 1720, 1730, are first identified from the program source code at step 1804. This may be accomplished by grouping program code that exhibits characteristics of stream processing, such as program loops. In another embodiment, a stream kernel may be defined by the user or programmer with appropriate annotation in the program source code. At decision step 1806, the input stream descriptors for each stream kernel are checked to see if there are data dependencies with the previous process. It there are no data dependencies in the stream descriptors, the stream descriptors are generated in a method described either in methods 800 and 900, as shown in the negative branch of the decision step 1806.

Referring again to FIG. 18, when there are data dependencies in the stream descriptors, as indicated in the positive branch of the decision step 1808, instructions are inserted in the program flow that are manifested as the stream loader, such as stream loader 1710. At step 1808, code is inserted in the stream loader to obtain the data that determines the stream descriptors required by the stream kernel identified at step 1804. In one embodiment, the code will execute on an object processor that is running a first process, such as first process 1610, and the code inserted at step 1808 will include a load from memory location such as registers or external memory. In another embodiment, the code may be executed on a programmable controller associated with a memory 210 or 215, and will be preloaded onto the programmable controller. Additional code on the object processor that is running a process such as the first process 1610 will include an activation signal, typically in a form of a register write, to initiate the code that is preloaded onto the programmable controller. In yet another embodiment, a hardware circuit that automatically generates stream descriptor based on methods described in methods 800 and 900 may be used with the stream loader. In this embodiment, the code loaded into the object processor that is running the first process 1610 includes code to transfer the data from memory location such as registers or external memory to the hardware circuit, as well as code to activate the hardware circuit.

Again referring to FIG. 18, at step 1810, code is inserted into the object processor that executes a process such as the first process 1610 to calculate the stream descriptor according to the methods 800 and 900. In another embodiment, the code to calculate the stream descriptors may be executed on a programmable controller associated with a memory 210 or 215, and will be preloaded onto the programmable controller. Additional code for the object processor that is running the first process may accomplish reception of a signal from the programmable controller that signals the completion of the calculation of stream descriptors by the programmable controller. This signal may come in the form of a register write or interrupt signal. In yet another embodiment, a hardware circuit that automatically generates stream descriptors based on methods described in methods 800 and 900 may be used. In this embodiment, the code loaded into the object processor that is running the first process is the same code as used in the embodiment using a programmable controller. The process ends with step 1812.

In an example embodiment of method 1800 wherein the input stream descriptors are dependent upon data values obtained during program execution, the input and output stream descriptors may be expressed in the compiler generated program binary using references to the storage locations of the dependent data values. Using compiler terminologies that are known in the art, each reference may be a pointer to one of the following: a register, a location in memory where the program symbol table stores program variables, a location in memory where global variables are stored, a program heap, a program stack, and the like. The stream loader may have access to the register and symbol table based on compiler generated instructions to obtain one or more of the input stream descriptors that are defined by dependent data values using one or more corresponding pointers, as described at step 1808.

With the stream loader code, data values from the first process 1610 will be obtained and used to calculate the necessary output stream descriptors for the input and output target data used by stream kernels. The stream loader code executes during normal operation of a program such as those described with reference to FIGS. 16 and 17, after the first process is completed. In one embodiment, the stream descriptors calculated by stream loader 1710 may be used to load new stream descriptors in memory 510 and 515 such that target data required by the object processor may be determined at run time and the memory hierarchy may configure its fetching operation accordingly.

In another example embodiment of method 1800, wherein the stream loader code generates output stream descriptors when dependent data values become available during program execution, the stream loader code may execute again during stream kernel execution to alter the target data patterns based on the same target data being transferred. An example of target data that the stream loader may use to alter target data patterns is a data stream that contains a packet header such as those used in communication and encryption protocols. The invocation of the stream loader code may occur after a certain number of target data have been transferred, after a certain type or pattern of target data has been detected, after a signal from the memory hierarchy is detected by the object processor, or after a particular instruction is executed by the object processor.

In yet another example embodiment of method 1800 and in reference to FIGS. 13-15, wherein two input stream descriptors describe two sets of target data, the stream loader code may generate output stream descriptors to describe target data that is the union of target data for two stream kernels. Both stream kernels may be new processes that have not yet started, and in such a case, the stream loader computes new output stream descriptors for initial use by the stream kernels. In another case related to parallel processing, wherein one of the stream kernels is already in progress of execution and transferring data, the stream loader may generate output stream descriptors by selecting input stream descriptors from the stream kernel in progress and other input stream descriptors for a stream kernel that has not started yet. In yet another case, where both stream kernels are already in progress of execution and transferring data, the stream loader may generate output stream descriptors for the union of target data used by both stream kernels.

It will be appreciated that by using the above method 1800, the memory hierarchy may transfer data in a manner that improves the bus capacity performance parameter in many situations where the output stream descriptors are data dependent and may not be defined before the program starts. In an example embodiment where a processing system such as that described with reference to FIG. 2 is used for image processing, the method 1800 allows stream kernels to be identified by the compiler even when the input stream descriptors in the image processing program are dependent on data values from images captured during program execution. Furthermore, the method 1800 allows for the memory hierarchy to modify its access patterns for improved bus capacity through the use of the stream loader that creates output stream descriptors based on data values from images captured during program execution.

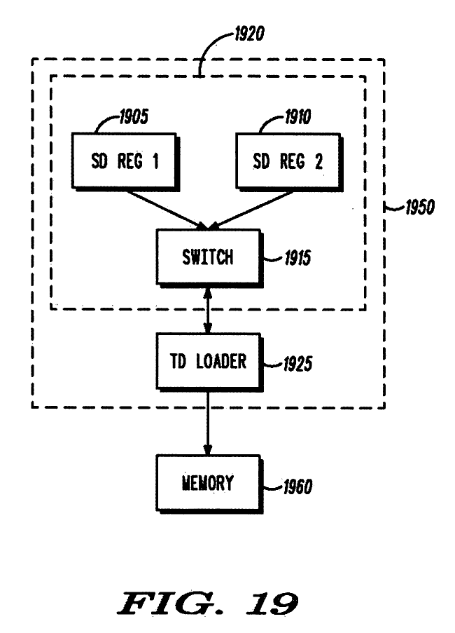

Referring to FIG. 19, a block diagram shows a memory controller 1950, in accordance with some embodiments of the present invention. The memory controller 1950, which is coupled to a memory 1960, comprises a stream descriptor selector (SD SELECTOR) 1920 coupled to a target data loader (TD LOADER) 1925. The stream descriptor selector 1920 comprises a first stream descriptor register (SD REG1) 1905 and a second stream descriptor register (SD REG2) 1910 that are each coupled to a switch 1915. The switch is coupled to the target data loader 1925 to control the loading of target data from a data stream according to first or second sets of stream descriptors that may be stored, respectively, in first and second stream descriptor registers 1905, 1910. The first and second sets of stream descriptors may be generated by any of the means described above. When the first and second sets of stream descriptors describe target data to be loaded into the memory from differing data streams, the switch 1915 controls the target data loader 1925 to first write the target data described by the first stream descriptors into memory 1960, then write the target data described by the second stream descriptors into memory 1960. When the first and second sets of stream descriptors describe target data to be loaded into the memory from the same data stream, however, and when the second set of stream descriptors are received while the memory loader is writing the first set of target data into the memory 1960, the switch 1915 controls the memory loader to immediately start using the second set of stream descriptors. Immediately in this context means that the second set of stream descriptors is used essentially as soon as the switch 1915 can calculate locations of the next target data without missing any current target data. It will be appreciated that the memory controller 1950 may use either set of the sets of stream descriptors stored in stream descriptor registers 1905, 1910 to read target data from memory 1960 to a another memory or to a processor, and this process may take place while a set of stream descriptors stored in another of the stream descriptor registers 1905, 1910 is used to load target data into the memory 1960. Furthermore, it will be appreciated that the stream descriptor selector 1920 may comprise more than two stream descriptor registers coupled to the switch 1915. In another example embodiment, stream descriptor registers 1905, 1910 may store a set of stream descriptors that describe the location of target data for the union of the first and second sets of target data. The memory controller 1950 may comprise an apparatus such as a state machine that operates without a central processing unit, which may be an application specific integrated circuit.

It will be appreciated that embodiments of the invention described herein may be comprised of one or more conventional processors and unique stored program instructions that control the one or more processors to implement, in conjunction with certain non-processor circuits, some, most, or all of the functions of a compiler or processor system that, among other things, generates executable code and setup parameters that control data transfer in the processing system and determines memory hierarchy configuration described herein. The non-processor circuits may include, but are not limited to signal drivers, clock circuits, power source circuits, and user input devices. As such, these functions may be interpreted as steps of a method to perform, among other things, generation of the executable code and setup parameters. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method used for controlling data transfer in a processing system, comprising:
obtaining a set of first input stream descriptors that describe data locations of a first set of target data embedded within a first data stream that can be transferred by the first data stream to a first device;
obtaining first physical parameters related to transferring the first set of target data to the first device; and
automatically generating a set of first output stream descriptors that can be used for transferring the first set of target data to the first device embedded within a second data stream, wherein the set of first output stream descriptors are determined by using at least one of the set of first input stream descriptors and at least one of the first physical parameters.

2. The method according to claim 1, further comprising determining whether a performance metric that is based on the set of first output stream descriptors is met.

3. The method according to claim 2, further comprising:
determining a system constraint that is used to generating the first output stream descriptors, wherein the system constraint is determined from the first physical parameters and a system constraint of a previous iteration; and
repeating the determination of a current system constraint and the automatic generation of the set of first output stream descriptors until the performance metric is met.

4. The method according to claim 3, wherein the set of first output stream descriptors are further determined by using at least one data value from the following sets of data values:
one or more target data values obtained during program execution; and
one or more data values of the first set of target data.

5. The method according to claim 4 wherein one or more stream descriptors in the sets of first input and first output stream descriptors may be expressed in the executable code as one or more corresponding pointers.

6. The method according to claim 1, wherein the set of first input stream descriptors and the first physical parameters are received by a compiler, further comprising compiling executable code that includes one or more transfer operations performed according to the set of first output stream descriptors.

7. The method according to claim 1, wherein the set of first input stream descriptors are received by a compiler, further comprising compiling executable code that performs the automatic generating of the set of first output stream descriptors.

8. The method according to claim 7, wherein the executable code that performs the automatic generating of the set of first output stream descriptors is executable by at least one of an object processor, a stream loader, and a memory controller.

9. The method according to claim 8, wherein the executable code that performs the automatic generating is executed based on one of the following events:
a number of target data have been transferred;
a pattern in the content of the target data has been detected;
a signal from the memory controller is detected; and
a particular instruction is executed by the object processor.

10. The method according to claim 8, wherein the executable code that performs the automatic generating of the set of first output stream descriptors is automatically executed after the dependent data value is available.

11. The method according to claim 1, wherein the set of first input stream descriptors and the physical parameters are received by a compiler, further comprising generating configuration settings for hardware that performs the automatic generating of the set of first output stream descriptors.

12. The method according to claim 1, wherein the sets of first input stream descriptors and first output stream descriptors each include at least one of a starting address, a STRIDE value, a SCAN value, a SKIP value, and a TYPE value.

13. The method according to claim 1, wherein the first physical parameters include parameters that affect at least one of bus width, setup time, number of cycles in a bus transfer, overhead in the data packet during transmission of data, bus capacitance, bus voltage swing and bus frequency.

14. The method according to claim 1, wherein the use of the set of first output stream descriptors to transfer the target data improves at least one of the latency, bandwidth, bus utilization, number of transfers, power consumption, and total buffer size of the transfer of the target data.

15. The method according to claim 1, wherein data inputs of a second device are coupled to data outputs of the first device, and further comprising:
obtaining second physical parameters related to the transfer of data to the second device, wherein in the step of generating a set of first output stream descriptors, the set of first output stream descriptors are further determined from the second physical parameters; and further comprising:
automatically generating from the set of first input stream descriptors, the first physical parameters, and the second physical parameters a set of second output stream descriptors for transferring the first set of target data to the second device.

16. The method according to claim 1, further comprising:
obtaining a set of second input stream descriptors that describe data locations of a second set of target data that can be transferred to the first device; wherein the transferring of the second set of target data is described by second input stream descriptors, further comprising;
generating from the sets of first and second input stream descriptors and the first physical parameters a set of first output stream descriptors for transferring all target data that is a union of the first and second sets of target data into the first device, embedded in the second data stream.

17. The method according to claim 1, further comprising generating one or more descriptors of the set of first input stream descriptors from a prior set of first input stream descriptors and at least one physical parameter value, while the prior set of first stream descriptors is in use by a stream kernel to transfer the first set of target data.

18. A software media that includes program code that is used for generating object code that performs the method according to claim 1, wherein the object code is generated from inputs made by a user that define one or more physical parameters and constraints and from source code.

19. A stream loader apparatus that performs the method according to claim 1.

20. A memory controller apparatus comprising:
memory loader that writes target data into a memory using a set of stream descriptors that describe data locations of a set of target data embedded within a data stream; and
stream descriptor switch that switches the set of stream descriptors from a set of first stream descriptors that describe locations of a first set of target data embedded in a first data stream to using a set of second stream descriptors that describe locations of the first set of target data while the memory loader is writing the first set of target data into the memory.
